(19) United States
(12) Patent Application Publication
(10) Pub. No.: US 2007/0106948 A1
(43) Pub. Date: May 10, 2007

(54) Improving message reply function in electronic devices

(75) Inventor: Kati Ala-Rantala, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/269,102

(22) Filed: Nov. 7, 2005

(51) Int. Cl. G06F 9/00

(52) U.S. Cl. 715/752

(57) ABSTRACT

The specification and drawings present a new method, apparatus and software product for improving a message reply function of an electronic device. This can result in reducing time for responding to messages and discarding messages which are obsolete. When the user of the electronic device selects (e.g., opens) a message and optionally provides a response message signal before creating the response message to this selected message, the electronic device, in response to the selecting the message or to the response message signal, automatically determines according to a predetermined criterion whether there are related messages (at least one related message) to this message which are received by the electronic device and, if the related messages exist, informing the user about the related messages, so these related messages can be considered by the user for creating the response message (e.g., the reply or the forward message).

### FIELD OF THE INVENTION

This invention generally relates to a message management and more specifically to improving a message reply function in an electronic device.

### BACKGROUND ART

When there are many messages (e.g., e-mails) in an inbox of an electronic device and the user starts reading and replying to those messages, he/she usually starts from the oldest message in order to get a better overview of what has been discussed and by whom. However, if there has been a long discussion on a certain subject and the e-mail chain is long, the user often answers to an earlier message and then goes on reading the rest of the messages (e.g., later e-mails). Very often the reply message just sent by the user is already obsolete, since later messages in the chain may have already solved the problem that was discussed in the specific message.

### DISCLOSURE OF THE INVENTION

According to a first aspect of the invention, a method for improving a message response function of an electronic device, comprises: selecting a message received in the electronic device; determining automatically according to a predetermined criterion by the electronic device whether there is at least one related message to the message which is received by the electronic device and, if the at least one related message exists according to the criterion, informing a user of the electronic device by the electronic device about the at least one related message, so the at least one related message can be considered by the user for creating a response message to the message.

According further to the first aspect of the invention, the method may further comprise: considering one related message out of the at least one related message by the user for creating the response message.

Further according to the first aspect of the invention, before the selecting the message in the electronic device, the method may comprise: receiving the message; and storing an identity of the message in a chain identifying related messages such that the electronic device can perform the determining.

Still further according to the first aspect of the invention, the at least one related message may be sent by at least one communication method out of: electronic mail communication method, multimedia messaging service (MMS) communication method, short message service (SMS) communication method, and instant message communication method.

According further to the first aspect of the invention, the message may be an e-mail message.

According still further to the first aspect of the invention, the message may be a multimedia messaging service (MMS).

According further still to the first aspect of the invention, the message may be a short message service (SMS) message or an instant message.

According yet further still to the first aspect of the invention, before the determining, the method may comprise of: providing a response message signal after selecting the message by a user of the electronic device before creating a response message to the message, wherein the determining is performed by the electronic device in response to the response message signal.

According to a second aspect of the invention, a computer program product comprises: a computer readable storage structure embodying computer program code thereon for execution by a computer processor with the computer program code characterized in that it includes instructions for performing the steps of the first aspect of the invention indicated as being performed by the electronic device.

According to a third aspect of the invention, an electronic device capable of improving a message reply function, comprises: a related message block, for selecting a message in the electronic device, for determining automatically according to a predetermined criterion whether there is at least one related message to the message which is received by the electronic device and, if the at least one related message exists according to the criterion, informing a user of the electronic device about the at least one related message, so the at least one related message can be considered by the user for creating a response message to the message; and a display, for displaying the message, the related messages and for displaying information about an identities of the related messages.

According further to the third aspect of the invention, the at least one message out of the at least one related message may be considered by the user for creating the response message.

Further according to the third aspect of the invention, the electronic device may further comprise: a receiving/sending module, for receiving the message. Further, the electronic device may comprise: a storage area, for storing the message and the related messages. Still further, an identity of the message after it is received may be added to a chain identifying related messages such that the related message block can perform the determining. Yet still further, the chain may be created by the related message block and stored in the storage area or in a message chain history storage area.

Still further according to the third aspect of the invention, the at least one related message may be sent by at least one communication method out of: electronic mail communication method, multimedia messaging service (MMS) communication method, short message service (SMS) communication method, and instant message communication method.

According further to the third aspect of the invention, the message may be an e-mail message, an instant message, a short message service (SMS) message or a multimedia messaging service (MMS) message.

According still further to the third aspect of the invention, the electronic device may be a computer, a communication device, a wireless communication device, a portable electronic device, a mobile electronic device or a mobile phone.

### BRIEF DESCRIPTION OF THE DRAWINGS

For a better understanding of the nature and objects of the present invention, reference is made to the following detailed description taken in conjunction with the following drawings, in which:

FIG. 1 is a block diagram of an electronic device for improving a message reply function, according to the present invention.

FIG. 2 is a flow chart demonstrating a performance of an electronic device for improving a message reply function, according to the present invention.

### MODES FOR CARRYING OUT THE INVENTION

A new method, system, apparatus and software product are presented for improving a message reply function of an electronic device. This can result (but is not limited to) reducing time for responding to messages and discarding messages which are obsolete.

According to an embodiment of the present invention, when a user selects a message (which can be stored in the electronic device, in the network or in both) or decides to reply to a message after selecting it, he/she is informed about other messages in a chain of related messages and offered a possibility to consider (e.g., view) those before completing the intended response message (e.g., a reply or a forward message). The message to be replied to can be (but is not limited to) an electronic mail (e-mail) message, a multimedia messaging service (MMS) message, a short message service (SMS) message, an instant message, etc. Thus according to embodiments of the present invention, when the user of the electronic device selects (e.g., opens) a message and optionally provides a response message signal before creating the response message to this selected message, the electronic device, in response to the selecting the message or to the response message signal, automatically determines, according to a predetermined criterion, whether there are related messages (at least one related message) to this message which are received by the electronic device and, if the related messages exist, informing the user about the related messages, so these related messages can be considered by the user for creating the response message (e.g., the reply or the forward message).

According to embodiments of the present invention, the chain of related messages can comprise messages sent by one communication method or by different communication methods. Then the communication methods can comprise at least one communication method out of:

a) electronic mail communication method,

b) multimedia messaging service (MMS) communication method,

c) short message service (SMS) communication method,

d) instant message communication method, and others.

Further, the electronic device can be (but is not limited to) a computer, a communication device, a wireless communication device, a portable electronic device, a mobile electronic device, a mobile phone, etc.

According to embodiments of the present invention, the related messages in the chain can be identified by different criteria or their combination thereof, e.g., using for such criterion a subject line, a sender address, a communication method, a date of the received message (i.e., received before or after the opened message to be replied to), etc. For example, the electronic device can identify the chain of the related messages in such a way that it includes only related messages that are received by the electronic device after receiving the message to be replied to, or the chain can comprise unread related messages received before the message to be replied to.

Furthermore, according to an embodiment of the present invention, the electronic device can (optionally) create and store a library of chains identifying related messages, wherein said library is constantly updated using the predetermined algorithm using criteria discussed above. After a message is received by the electronic device, the identity of the received message is added to an appropriate chain identifying related messages such that the electronic device can easily perform the determining of the related messages when needed. Also the identity of some messages can be deleted from the appropriate chain using said predetermined algorithm, e.g. if this message has been already responded to, or read, or become old, etc.

There are many variations for implementing various embodiments of the present invention. For example, when the user selects/opens a message and decides to reply/forward it, there is a dialog created on a display of the electronic device that lists the related messages identified according to the predetermined criterion and the user can select (open) any of these messages before creating a response message to the originally selected message. Moreover, the dialog can only inform that there is at least one related message (or multiple messages) identified according to the predetermined criterion and the user can select whether he/she wants to see the message before creating a response message.

Furthermore, if the user opens one of the related messages and decides to respond to it instead of responding to the originally selected/opened message, the user can choose a reply/forward function to create a response to this related message and, when he/she does that, it will automatically close the originally selected/opened message. Finally, if the user decides,after selecting the related message, that this related message is not relevant after all, he/she can have an option of returning to the original/previous/first message.

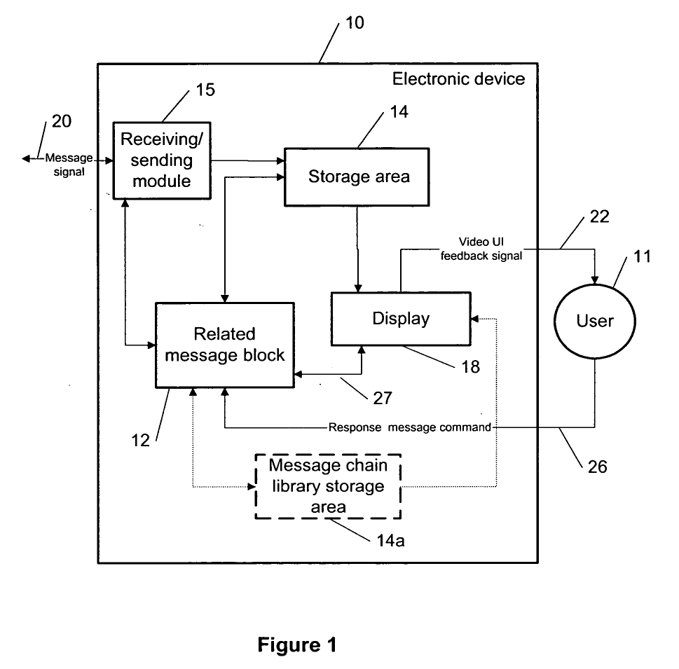

FIG. 1 shows one example among others of a block diagram of an electronic device 10 for improving a message reply function, according to the present invention. The electronic device 10 can be, e.g., a computer, a communication device, a wireless communication device, a portable electronic device, a mobile electronic device, a mobile phone, etc.

A receiving/sending module 15 receives or sends through a communication line 20 a message (e.g., the e-mail message, the MMS message, the SMS message, the instant message, etc.). The received and sent messages can be generated by a related message block 12 and provided to the receiving/sending module 15 for sending out. The message storage area 14 can be routinely used for storing the received, as well as, sent messages. It is noted that in addition or alternatively, the received messages can be stored on a server of a network. The messages can be displayed on a display 18, so a user 11 of the electronic device 10 can read them (as shown as a video UI feedback signal 22). The user 11 can provide instructions to the block 12 through a user interface (UI) wherein a UI function can be performed by the display 18.

When the user 11 selects and optionally opens a message (i.e., it is displayed on the display 18) and optionally provides a response message command 26 for creating a response (e.g., a reply or forwarding) message to the opened message, the block 12 automatically determines, according to a predetermined criterion, (as described above) whether there are related messages (or the chain of related messages or at least one related message) to this message which are received by the electronic device 10 and, if the related messages exist, informing the user 11 about the related messages (e.g., using a communication line 27 and a display 18 are related messages identified according to the predetermined criterion and the dialog can comprise an option like “show me the message(s)” or “ignore the message(s)”), so these related messages can be considered by the user when creating the reply message. It is noted that the related messages can be stored in the storage area 14 and/or on the server of the network.

According to embodiments of the present invention, the related messages in the chain can be identified by the block 12 using different criteria or their combination, e.g., using for such criterion a subject line, a sender address, a communication method, a date of the received message (i.e., received before or after the opened message to be replied to), etc. Thus in one embodiment, the block 12 can scan all messages received by the electronic device 10 using different communications methods (e.g., e-mail, MMS, SMS, the instant message, etc.) and determine related messages using the predetermined criterion as discussed above. If the block 12 finds the related messages, these messages are automatically provided to the user 11 (e.g., the message listing the related message can be automatically shown on the display 18).

Moreover, according to a further embodiment of the present invention, the electronic device 11 can optionally create and store a library of chains identifying related messages, wherein said library is constantly updated using the predetermined algorithm as described above. After a message is received by the module 15, the identity of the received message can be added to an appropriate chain identifying related messages and stored in a message chain library storage area 14a such that the electronic device 11 can easily perform (e.g., using the block 12) the determining of the related messages when needed. Also the identity of some messages can be deleted from the appropriate chains stored in the block 14a using said predetermined algorithm, e.g., if this message is responded to, or read, or become old, etc. According to an embodiment of the present invention, the block 14a can be a part of the block 14 or it can be a separate memory block.

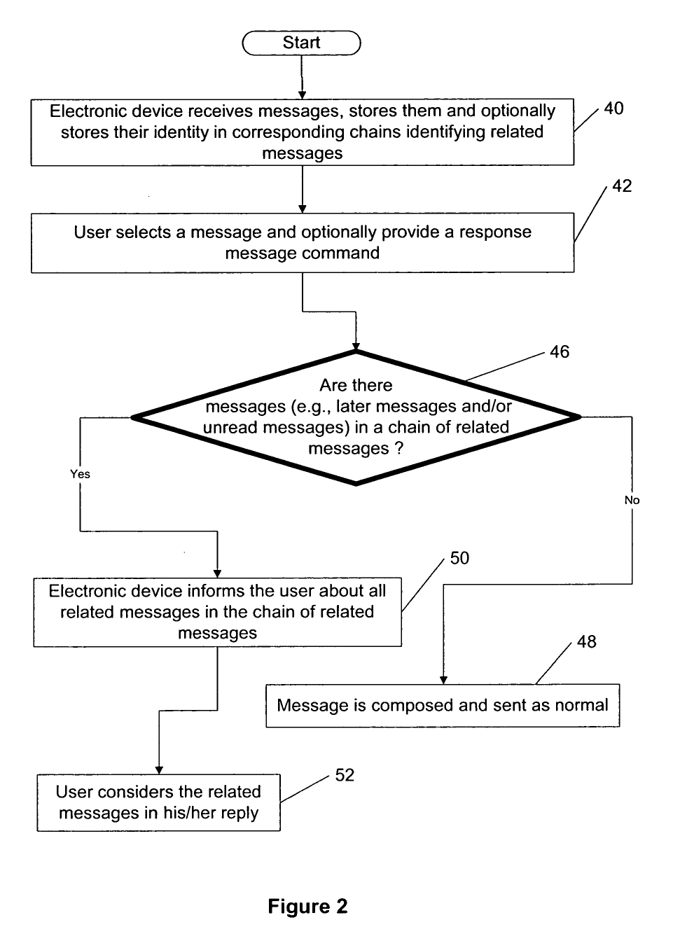

FIG. 2 is a flow chart demonstrating a performance of an electronic device 10 for improving a message reply function, according to the present invention.

The flow chart of FIG. 2 represents only one possible scenario among others. In a method according to the present invention, in a first step 40, the electronic device 10 receives messages, stores them in a storage area 14 and optionally stores (e.g., in the storage area 14 or in the message chain library storage area 14a) their identity in corresponding chains for identifying related messages according to embodiments of the present invention described above. In a next step 42, the user 11 selects one of the messages stored in the storage area 14. and optionally provides a respond message command 26 to the related message block 12.

In a next step 46, it is ascertained by the electronic device 10 (e.g., by the related message block 12) whether there are related messages (e.g., later messages and/or unread messages in a chain of related messages). If that is not the case, in a next step 48, the user 11 composes the response message and sends it using the module 15 as normal. If, however, it is determined that there are related messages, as found by the related message block 12 using the predetermined criterion according to the embodiments of the present invention, in a next step 50, the electronic device 11 automatically informs the user 11 (e.g., displaying the listing of the related messages on the display 18) about relevant related messages in the chain of related messages. Finally, in a next step 52, the user composes the response message considering related messages and sends the response message using the block 15.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for improving a message response function of an electronic device, comprising:
selecting a message received in said electronic device;
determining automatically according to a predetermined criterion by said electronic device whether there is at least one related message to said message which is received by the electronic device and, if the at least one related message exists according to said criterion, informing a user of the electronic device by the electronic device about said at least one related message, so said at least one related message can be considered by the user for creating a response message to said message.

2. The method of claim 1, further comprising:
considering one related message out of said at least one related message by the user for creating said response message.

3. The method of claim 1, wherein before said selecting said message in said electronic device, the method comprises:
receiving said message; and
storing an identity of said message in a chain identifying related messages such that said electronic device can perform said determining.

4. The method of claim 1, wherein said at least one related message is sent by at least one communication method out of:
electronic mail communication method,
multimedia messaging service (MMS) communication method,
short message service (SMS) communication method, and
instant message communication method.

5. The method of claim 1, wherein said message is an e-mail message.

6. The method of claim 1, wherein said message is a multimedia messaging service (MMS).

7. The method of claim 1, wherein said message is a short message service (SMS) message or an instant message.

8. The method of claim 1, wherein before said determining, the method comprises of:
providing a response message signal after selecting said message by a user of said electronic device before creating a response message to said message, wherein said determining is performed by said electronic device in response to said response message signal.

9. A computer program product comprising: a computer readable storage structure embodying computer program code thereon for execution by a computer processor with said computer program code characterized in that it includes instructions for performing the steps of the method of claim 1 indicated as being performed by the electronic device.

10. An electronic device capable of improving a message reply function, comprising:
a related message block, for selecting a message in said electronic device, for determining automatically according to a predetermined criterion whether there is at least one related message to said message which is received by the electronic device and, if the at least one related message exists according to said criterion, informing a user of the electronic device about said at least one related message, so said at least one related message can be considered by the user for creating a response message to said message; and
a display, for displaying said message, said related messages and for displaying information about an identities of said related messages.

11. The electronic device of claim 10, wherein at least one message out of said at least one related message is considered by the user for creating said response message.

12. The electronic device of claim 11, further comprising:
a receiving/sending module, for receiving said message.

13. The electronic device of claim 12, further comprising:
a storage area, for storing said message and said related messages.

14. The electronic device of claim 12, wherein an identity of said message after it is received is added to a chain identifying related messages such that said related message block can perform said determining.

15. The electronic device of claim 14, wherein said chain is created by said related message block and stored in the storage area or in a message chain history storage area.

16. The electronic device of claim 10, wherein said at least one related message is sent by at least one communication method out of:
electronic mail communication method,
multimedia messaging service (MMS) communication method,
short message service (SMS) communication method, and
instant message communication method.

17. The electronic device of claim 10, wherein said message is an e-mail message, an instant message, a short message service (SMS) message or a multimedia messaging service (MMS) message.

18. The electronic device of claim 10, wherein said electronic device is a computer, a communication device, a wireless communication device, a portable electronic device, a mobile electronic device or a mobile phone.
